(19) United States
(12) Patent Application Publication
(10) Pub. No.: US 2008/0077510 A1
(43) Pub. Date: Mar. 27, 2008

(54) Method And System For Providing Security Surveillance And Shelf Monitoring Functions

(75) Inventor: Corne Dielemans, Kalmthout (BE)

Correspondence Address: DR. MARK M. FRIEDMAN;C/O BILL POLKINGHORN - DISCOVERY DISPATCH, 9003 FLORIN WAY, UPPER MARLBORO, MD, 20772, US

(73) Assignee: POLYMER LOGISTICS BV, Bergen op Zoom (BE)

(21) Appl. No.: 11/533,788

(22) Filed: Sep. 21, 2006

(51) Int. Cl. G06Q 10/00

(52) U.S. Cl. 705/28

(57) ABSTRACT

A system and a method for providing shelf monitoring functions to a retail system including a video-based security system such that both the security and the current product distribution in a product storage area are monitored using the same video camera network. The method includes acquiring a video image of at least a portion of at least one shelf using at least one video camera mounted in a fixed location and directing the video image to a shelf monitoring module of a processing system and to a security module of the processing system

### FIELD AND BACKGROUND OF THE INVENTION

The present invention relates to systems for video viewing shelves and determining which products stored thereon need to be re-stocked and, in particular, it concerns a system that utilizes fixed video cameras for providing security surveillance and shelf monitoring functions

It is known to distribute video surveillance cameras throughout retail store space for security purposes.

It is also known to use cameras to record items stored on a shelf and to use data obtained from the camera to determine product distribution

U.S. Pat. No, 6,738,687 to Hanel discloses a storage shelf system that includes a digital camera The data obtained from the digital camera is used to generate a visual display of the contents of a container deployed on the shelf The data can also be used to locate any unused storage space in the container

French Patent No 2,785,687 to Del Rabal relates to a method for automatically locating and identifying products on a shelf, display rack or gondola in a retail store. The method works by moving a camera along the whole length of the shelf and taking a sequence of pictures of adjacent partial areas of the shelf and of the products located in these areas. Digital signals corresponding to each respective taken picture are then generated. That data is then used to provide an encoded digital signal or “signature” signal for each of the products on the shelf. Each of the product “signature” signals is then compared to previously set reference “signature” signals, respectively corresponding to various previously identified products, in order to recognize and determine the location of every product present on the shelf, from the results of this comparison.

The present state of the art employs function-dedicated cameras. That is, cameras for surveillance only and other cameras for product location, thereby creating a redundancy in camera usage. Further, the prior art does not provide a system for product location using fixed cameras.

There is therefore a need for a system that utilizes fixed video cameras for providing security and shelf monitoring functions.

### SUMMARY OF THE INVENTION

The present invention is a system that utilizes fixed video cameras for providing security and shelf monitoring functions.

According to the teachings of the present invention there is provided, a method for using the same video network to provide security and shelf monitoring functions, the method comprising: a) providing a video network having at least one video camera deployed in a fixed location, the at least one video camera being in electronic communication with at least a processing system including at least one processor, the processing system including a security module and a shelf monitoring module; b) directing security video image data acquired by tile video camera to the security module so as to monitor security; and c) directing shelf monitoring video image data acquired by the video camera to the shelf monitoring module.

According to a further teaching of the present invention, there is also provided monitoring product distribution on at least one shelf.

According to a further teaching of the present invention, there is also provided analyzing the product distribution by determining size and location of empty shelf space on the at least one shelf.

According to a further teaching of the present invention, there is also provided analyzing the product distribution by determining the distribution of the at least one product adjacent to an outer edge of the at least a portion of the shelf.

According to a further teaching of the present invention, there is also provided analyzing the product distribution by determining the distribution of the at least one product through at least a partial depth of the at least a portion of the shelf.

According to a further teaching of the present invention, there is also provided analyzing the product distribution by comparing current the video image data to video image data of a reference template.

According to a further teaching of the present invention, there is also provided a learning mode for introducing a new product.

According to a further teaching of the present invention, there is also provided a learning mode for learning, the characteristics of the various shelves in a field of view of the camera.

According to a further teaching of the present invention, there is also provided generating from the processing system a notification of results of the monitoring product distribution on at least one shelf.

According to a further teaching of the present invention, the notification is implemented as any one from a list including: a display window on a computer monitor, an audio signal, an SMS message, and e-mail.

According to a further teaching of the present invention, there is also provided assessing video coverage of the shelf.

According, to a further teaching of the present invention, there is also provided adding at least one video camera so as to enhance the video coverage.

There is also provided according to the teachings of the present invention, a system for monitoring both security and shelf re-stocking issues using the same video network, the system comprising: a) at least one video camera deployed so as to view at least a portion of a product storage area; and b) at least one processing system including a security module and a shelf monitoring module, the processing system being in data communication with the at least one video camera; wherein security video image data received from the video camera is directed to the security module and shelf monitoring video image data received from the video camera is directed to the shelf monitoring module.

According to a further teaching of the present invention, the processing system is configured for monitoring product distribution on at least one shelf located in the product storage area.

According to a further teaching of the present invention, the processing system is configured for analyzing the product distribution determining size and location of empty shelf space on the at least one shelf.

According to a further teaching of the present invention, the processing system is configured for analyzing the product distribution by determining the distribution of the at least one product adjacent to an outer edge of the at least a portion of the shelf.

According to a further teaching of the present invention, the processing system is configured for analyzing the product distribution includes determining the distribution of the at least one product through at least a partial depth of the at least a portion of the shelf.

According to a further teaching of the present invention, the processing system is configured for analyzing the product distribution by comparing current the video image data to video image data of a reference template.

According to a further teaching of the present invention, the processing system is configured with a learning mode for introducing a new product.

According to a further teaching of the present invention, the processing system is configured with a learning mode for learning the characteristics of the various shelves in a field of view of the camera.

According to a further teaching of the present invention, the processing system is configured for generating, a notification of results of the monitoring product distribution on at least one shelf.

According to a further teaching of the present invention, there is also provided deploying at least one video camera so as to enhance video coverage of the at least a portion of a product storage area.

### BRIEF DESCRIPTION OF THE DRAWINGS

The invention is herein described, by way of example only, with reference to the accompanying drawings, wherein:

FIG. 1 is a schematic side cross-sectional view of an exemplary product storage area according to the teachings of the present invention, having ceiling mounted video cameras;

FIG. 2 is a schematic side cross-sectional view of an exemplary product storage area according to the teachings of the present invention, having a wall-mounted video camera;

FIG. 3 is a schematic front view of an exemplary product storage area according to the teachings of the present invention, having a ceiling mounted video camera;

FIG. 4 is a schematic view of an embodiment of the system of the present invention in which both the shelf monitoring module and the security module are included on a single processing unit; and

FIG. 5 is a schematic view of an embodiment of the system of the present invention in which the processing system includes a separate processing unit for each of the shelf monitoring module and the security module.

### DESCRIPTION OF THE PREFERRED EMBODIMENTS

The present invention is a system that utilizes fixed video cameras for providing security and shelf monitoring functions.

The principles and operation of a system that utilizes fixed video cameras for providing security and shelf monitoring functions according to the present invention may be better understood with reference to the drawings and the accompanying description.

By way of introduction, the present invention relates to a system and a method for monitoring both the security and the current product distribution in a product storage area using the same video camera network.

Although the accompanying figures relate to shelves deployed in a retail area of the store, it should be noted that the phrase “a product storage area” is used herein to refer to substantially any area in which items are placed. Such placement may be for display in the retail section of a store, for example. Alternatively, such placement may be in a warehouse or storage area, such as the “back room” of a retail store, in which the items are placed until they are brought out to the retail section of the store for display.

The system of the present invention utilizes a network of video cameras to view a product storage area. The video image data acquired by the video cameras is directed to two different modules in the processing system, a shelf monitoring module and a security module. The video image data, therefore, is analyzed with regard to both security issues and product distribution. It should be noted that the term “video image data” is used herein to refer to substantially any output produced by the video cameras. Further, the video cameras may acquire the video image at substantially any frame rate known in the art, including rates that are considered still images. It will be appreciated that the video image data may be processed as, but not limited to, moving images and as still images. It will be understood that the sampling rate of the security module may be different from the shelf monitoring module and therefore, the processing system may send different frames to each module.

It will also be understood that not all of the video image data acquired is required for analysis by the security module and likewise, not all of the video image data acquired is required for analysis by the shelf monitoring module Therefore, the processing system may be configured so as to direct only the security relevant video image data, referred to herein as “security relevant video image data”, to the security module and to direct only the shelf monitoring relevant video image data, referred to herein as “shelf monitoring video image data”, to the shelf monitoring module. In a simplest embodiment, such relevance may be determined for the security module based on the difference between the frame rate of the video camera and refresh rate of the video display monitor. Relevance may be determined for the shelf monitoring module based on analyzing one frame, or a series of a predetermined number of frames, at a predetermined time interval such as, for example, every 30 minutes, hourly, or every two hours It should be noted that at substantially any given time the video image data being analyzed by the shelf monitoring module may be the same or different from the video image data being analyzed by the security module. Therefore, the phrases “security video data” and “shelf monitoring video data” as used herein may, or may not refer to the same data being analyzed at substantially any given time.

In order to compensate for, and eliminate if necessary, objects such as shoppers in the store moving through the field of view of a particular camera, multiple frames may be processed together so that a passing shopper is not interpreted as an empty shelf This may be accomplished by comparing pixels of successive frames and rejecting any that are not constants Alternatively, if two or more cameras provide a view of the same shelve from different angles, the video image data from the two cameras may be compared and any non-corresponding data may be rejected.

It should be noted that the video cameras of the present invention may be configured to pan a predefined portion of the product storage area. Alternately, the video cameras of the present invention may be configured to provide a static view of a predefined portion of the product storage area.

The analysis of the video image data by the security module may be in the form of displaying the video image data as a video image displayed on a video monitor for surveillance viewing by security personnel. Alternately or additionally, the video image data may be analyzed by a security related computer program containing a security algorithm as is known in the art so as to further assist security personnel.

The analysis of the video image data by the shelf monitoring nodule is done in order to determine the product re-stocking needs of the products arranged on the shelves viewed by the video cameras. Therefore, at least portions of the same video image data is analyzed both for security purposes and product re-stocking needs.

It will be appreciated that the processing system may include separate processing units for the shelf monitoring module and the security module Alternatively, the shelf monitoring module and the security module may be included on a single processing unit, Output resulting from the security and re-stocking, analysis may be displayed on a single display monitor or on separate dedicated display monitors. If the output is to be displayed on a single monitor, it may be displayed using a split screen arrangement or as one window superimposed over another window. For example, the video image may be continuously displayed “full screen” on the monitor for security purposes and a pop-up window may be activated to display the re-stocking analysis results. Such a pop-up window may be activated on demand or automatically as per predetermined criteria.

Alternatively, the output from the shelf monitoring module may be in the form of, but need not be limited to, an automated audio output, an SMS message, e-mail or substantially any other type of message that is sent directly or via any available local or wide area network. Preferably, the re-stocking analysis results are sent to the storage location from which the shelves are to be replenished or to the individual responsible for such replenishment.

As will be discussed in greater detail below, a product distribution and re-stocking program included in the shelf monitoring module may be configured to analyze, by non-limiting example, the distribution of products adjacent to an outer edge of the shelf, throughout the full depth of the shelf, or solely to identify empty shelf space Such product distribution and re-stocking program may include any one or combination of suitable algorithms known in the art such as, but not limited to, shape recognition algorithms.

The program of the shelf monitoring module may also include a learning mode for introducing a new product The learning mode may include passing each new product in front of a camera for the shelf monitoring module to learn the visual signature (pattern) of the product.

The shelf monitoring module may also include a learning mode in which the system learns the characteristics of the various shelves in view. Such characteristics may include, but are not limited to, the physical dimensions and visible depth of the various shelves, and/or identifying overlap of camera fields of view.

In a particularly simple implementation, when the viewed shelves are full according to a predetermined layout, a “snapshot” for each camera view may be acquired. The snapshot is then used as a reference template which the shelf monitoring module can then test correlation to that view over ongoing processing. That is to say, tile shelf monitoring module can compare the current view, or video image data, to the video image data of the reference template. When the predetermined layout of shelf is to be changed, the store staff can then arrange the shelves according to the new layout and then acquire a “reset snapshot”.

Such an implementation is particularly useful when the system is configured to provide notification of the disarrangement of shelves, such as products not arranged according to the programmed reference template, even when the shelf space is fully covered.

The processing system may be configured to assess video coverage of the shelving, and if so indicated, additional video cameras may be added in order to enhance video coverage of the shelving. This is particularly important when retrofitting an existing security camera network to include the shelf monitoring module of the present invention.

Since most, if not all, retail stores have some kind of security surveillance system that includes video cameras, it will be readily appreciated that the system of the present invention is of value for identifying incompletely stocked or badly arranged shelves with bare space alone the front edge, even if coverage of the depth of shelf is partial, thereby providing valuable added functionality when investment in a dedicated camera-based system would be prohibitive.

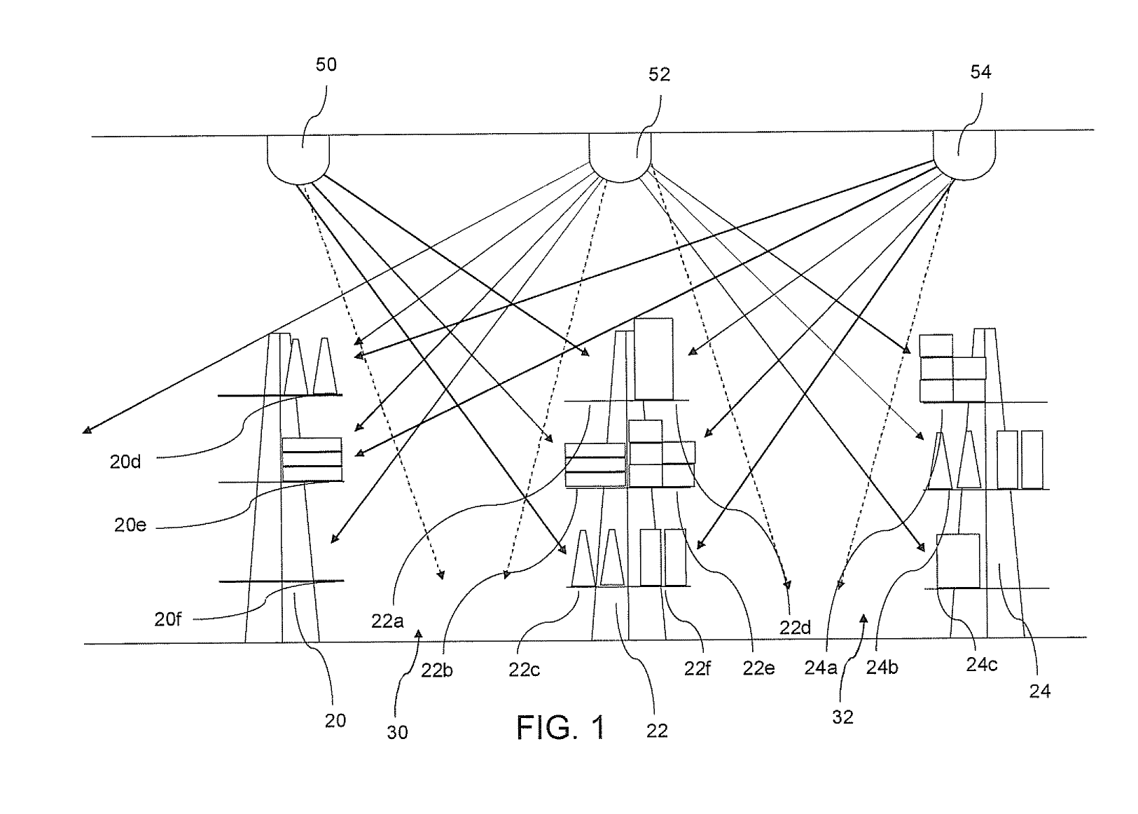

Referring now to the drawings, FIG. 1 illustrates products arranged on three shelving units 20, 22 and 24 that are separated by isles 30 and 32. Cameras 50, 52 and 54 are mounted on the ceiling

As illustrated by the solid-line arrows, camera 50 has a view of shelves 22a, 22b and 22c. In this illustration, the analyzing of the product distribution on the shelf so as to determine if the distribution is indicative of a need to re-stock at least a portion of the shelf may be based on the distribution of the products adjacent to the outer edge of the shelf The broken-line arrow illustrates the view of isle 30 provided by camera 50, Camera 52 has a view of shelves 20d, 20e, 20f, 24a, 24b and 24c, and of both isles 30 and 32. Camera 54 has a view of shelves 20d, 20e, 22d, 22e, and 22f, and of isle 32.

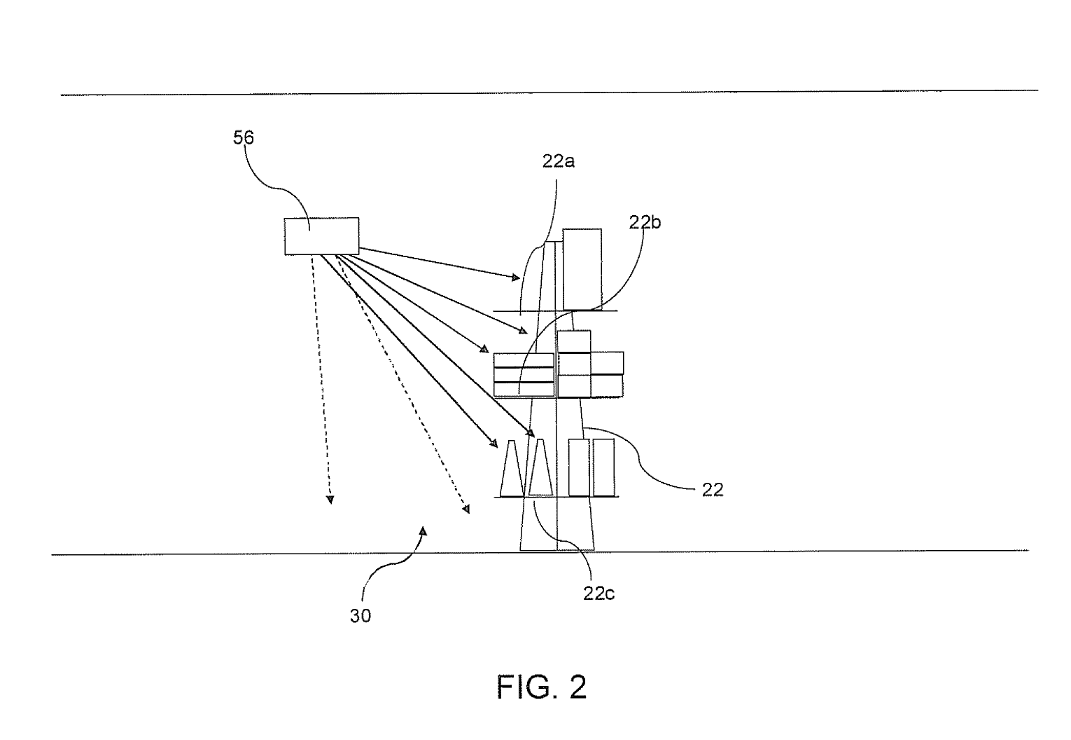

The view of the shelves provided by cameras 50, 52 and 54 is limited to the front edge of the lower shelves and to a partial depth of the upper shelves. An assessment of video coverage of the shelving provided by cameras 50, 52 and 54 may indicate the need for an additional video camera in order to enhance video coverage of the shelving. FIG. 2 illustrates such an alternative deployment of a video camera in the network Here, video camera 56 is mounted on a wall, for example, in a location that is lower than the ceiling mounted cameras 50, 52 and 54 of FIG. 1. The mount arrangement provides camera 56 with a deeper view of the shelves in its field of view such as shelves 22a, 22b and 22c illustrated here. In this illustration, the analyzing of the product distribution on the shelf so as to determine if the distribution is indicative of a need to re-stock at least a portion of the shelf may be based on the distribution of the products through at least a partial depth of the shelf.

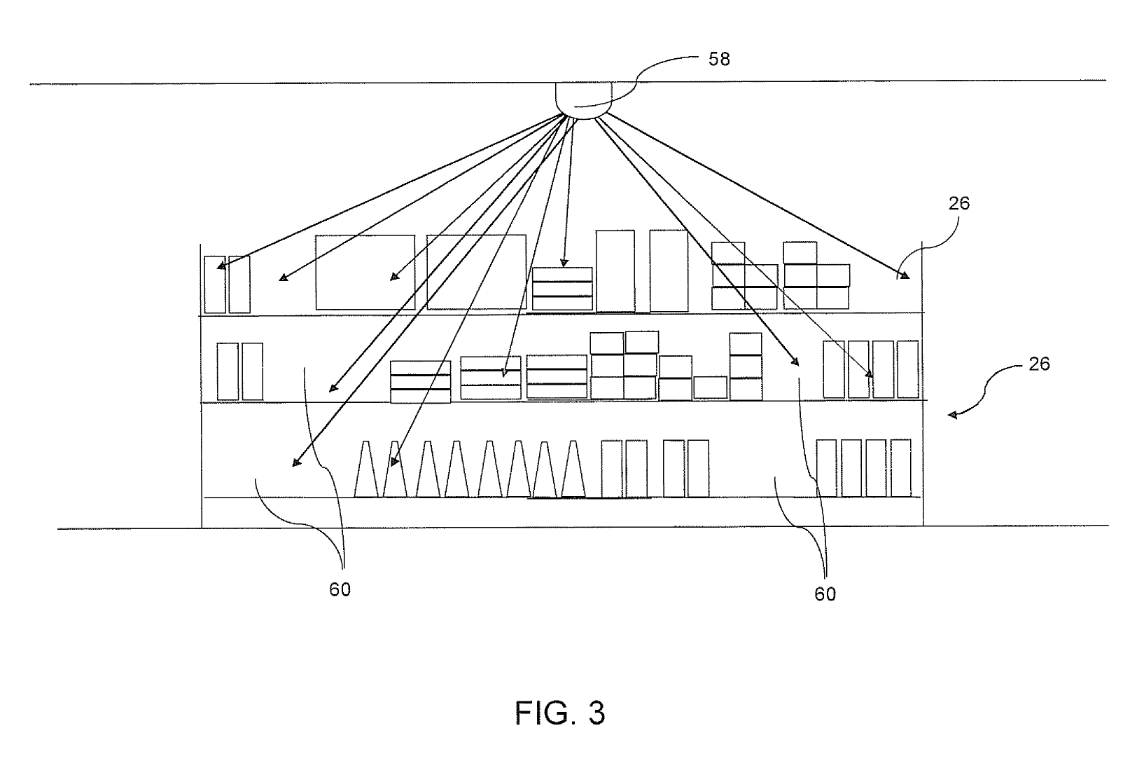

FIG. 3 illustrates the view of the products shelving, unit 26 provided by camera 58, In this illustration, the analyzing of the product distribution on the shelf so as to determine if the distribution is indicative of a need to re-stock at least a portion of the shelf may include determining size and location of fully empty shelf space 60 and/or partially empty space 62 on the shelf.

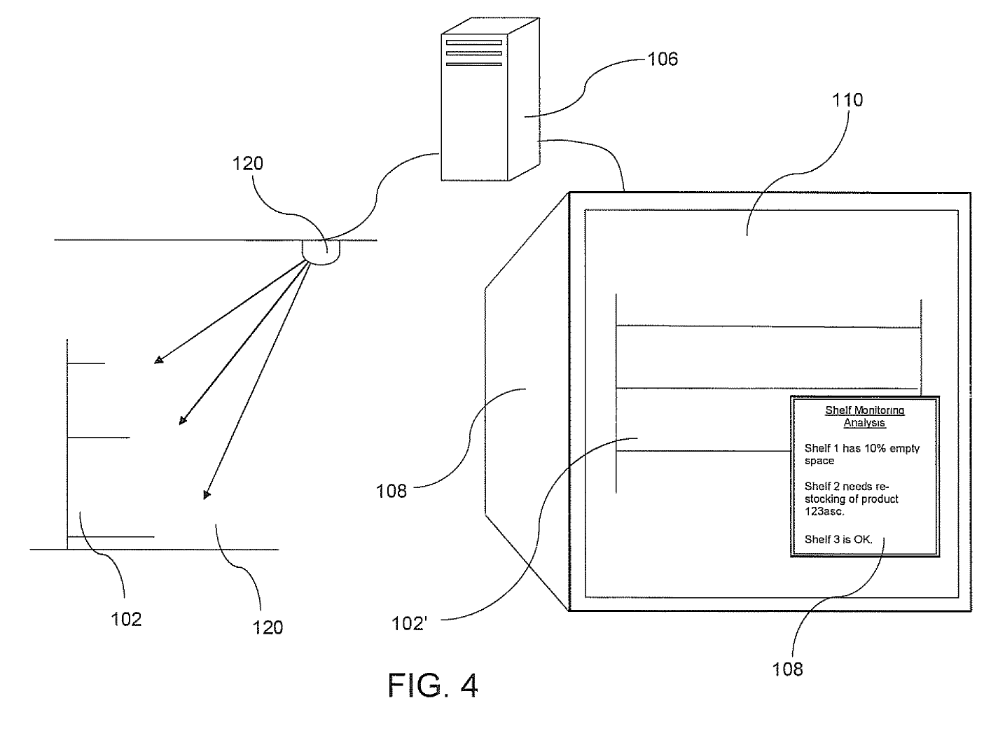

As illustrated in FIG. 4, the system of the present invention may be configured such that the video image of shelving unit 102 and of isle 120 acquired by camera 104 may be directed to the shelf monitoring module and the security module that are included on a single processing unit 106. The video image 102′ of shelf 102 and 120 is continuously displayed in “full screen” mode 110 on the monitor 108 for security purposes and a pop-up window 112 is displaying the shelf monitoring, analysis results provided by the shelf monitoring module

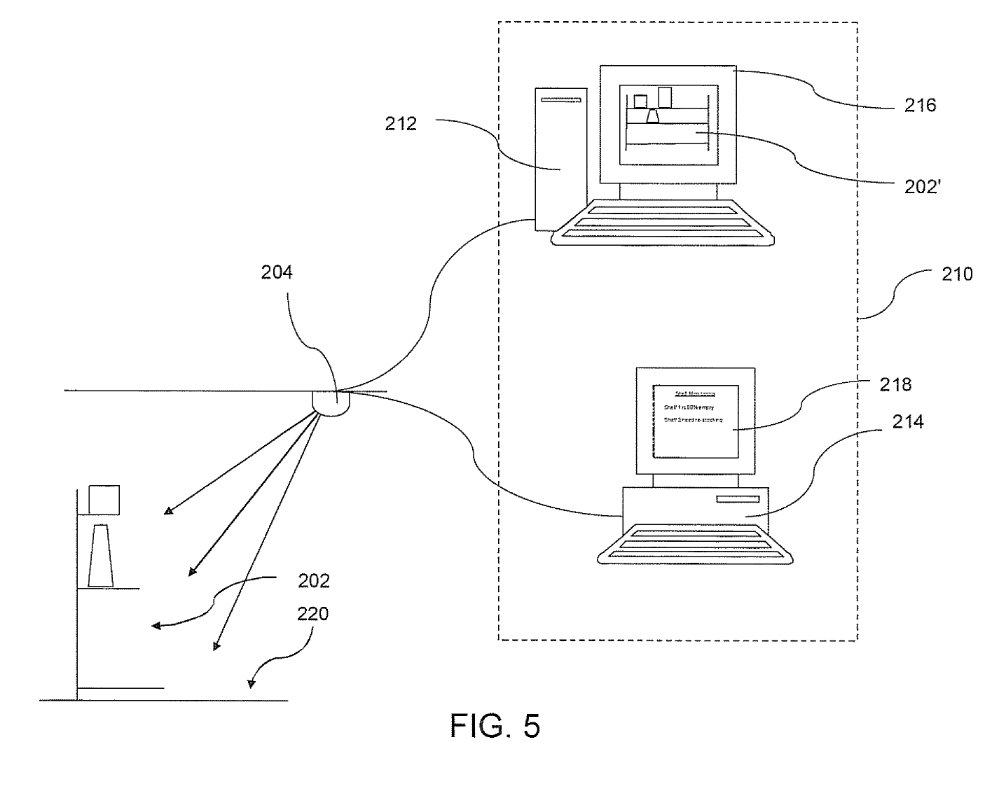

As illustrated in FIG. 5, the video image data of shelving unit 202 and isle 220 acquired by video camera 204 is directed to two different processing units in the processing system 210. The security module is configured on processing unit 212 and a video image 212′ is displayed on the display monitor 216. The shelf monitoring module is configured on processing unit 214 and the results of the shelf monitoring analysis provided by the shelf monitoring module are displayed on the display monitor 218.

It will be appreciated that the above descriptions are intended only to serve as examples and that many other embodiments are possible within the spirit and the scope of the present invention.

What is claimed is:

1. A method for using the same video network to provide security and shelf monitoring functions, the method comprising:
(a) providing a video network having at least one video camera deployed in a fixed location, said at least one video camera being in electronic communication with at least a processing system including at least one processor, said processing system including a security module and a shelf monitoring module;
(b) directing security video image data acquired by said video camera to said security module so as to monitor security; and
(c) directing shelf monitoring video image data acquired by said video camera to said shelf monitoring module.

2. The method of claim 1, further including monitoring product distribution on at least one shelf

3. The method of claim 2, further including analyzing said product distribution by determining size and location of empty shelf space on said at least one shelf.

4. The method of claim 2, further including analyzing said product distribution by determining said distribution of said at least one product adjacent to an outer edge of said at least a portion of said shelf,

5. The method of claim 2, further including analyzing said product distribution by determining said distribution of said at least one product through at least a partial depth of said at least a portion of said shelf.

6. The method of claim 2, further including analyzing said product distribution by comparing current said video image data to video image data of a reference template.

7. The method of claim 2, further including a learning mode for introducing a new product.

8. The method of claim 2, further including a learning mode for learning the characteristics of the various shelves in a field of view of said camera.

9. The method of claim 2, further including generating from said processing system a notification of results of said monitoring product distribution on at least one shelf.

10. The method of claim 9, wherein said notification is implemented as any one from a list including: a display window on a computer monitor, an audio signal, an SMS message, and e-mail.

11. The method of claim 1, further including assessing video coverage of said shelf.

12. The method of claim 7, further including adding at least one video camera so as to enhance said video coverage.

13. A system for monitoring both security and shelf re-stocking issues using the same video network, the system comprising:
(a) at least one video camera deployed so as to view at least a portion of a product storage area; and
(b) at least one processing system including a security module and a shelf monitoring module, said processing system being in data communication with said at least one video camera;
wherein security video image data received from said video camera is directed to said security module and shelf monitoring video image data received from said video camera is directed to said shelf monitoring module.

14. The system of claim 13, wherein said processing system is configured for monitoring product distribution on at least one shelf located in said product storage area.

15. The system of claim 14, wherein said processing system is configured for analyzing said product distribution determining size and location of empty shelf space on said at least one shelf.

16. The system of claim 14, wherein said processing system is configured for analyzing said product distribution by determining said distribution of said at least one product adjacent to an outer edge of said at least a portion of said shelf.

17. The system of claim 14, wherein said processing system is configured for analyzing said product distribution includes determining said distribution of said at least one product through at least a partial depth of said at least a portion of said shelf.

18. The system of claim 13, wherein said processing system is configured for analyzing said product distribution by comparing current said video image data to video image data of a reference template.

19. The system of claim 13, wherein said processing system is configured with a learning mode for introducing a new product.

20. The system of claim 13, wherein said processing system is configured with a learning mode for learning the characteristics of the various shelves in a field of view of said camera.

21. The system of claim 13, wherein said processing system is configured for generating a notification of results of said monitoring product distribution on at least one shelf.

22. The system of claim 13, further including deploying at least one video camera so as to enhance video coverage of said at least a portion of a product storage area.
